(19) United States
(12) Patent Application Publication
(10) Pub. No.: US 2004/0034636 A1
(43) Pub. Date: Feb. 19, 2004

(54) Method, system and computer readable medium for duplicate record detection

(76) Inventors: Ramakanth Vallur, Bangalore (IN); Chandrasekhar Sarasvati Revur, Tirupati (IN)

Correspondence Address: HEWLETT-PACKARD COMPANY, Intellectual Property Administration, P. O. Box 272400, Fort Collins, CO, 80527-2400, US

(21) Appl. No.: 10/219,160

(22) Filed: Aug. 15, 2002

(51) Int. Cl. G06F 7/00

(52) U.S. Cl. 707/8

(57) ABSTRACT

A method of determining if a given record is a duplicate of one of a list of records is disclosed. A single piece of information, such as a product of prime numbers unique to each record in the list is obtained. Similarly, a unique piece of information, such as a unique prime number, is obtained for the given record. The product is divided by the unique prime number of the given record. A remainder in the division operation indicates that the given record is not a duplicate.

### BACKGROUND

This invention relates in general to the field of data processing, and more specifically to record processing and duplicate record detection.

Many industries, such as the telecommunications, insurance and banking industries, rely on computer systems to receive, process, manipulate, and retrieve information. The information received by the computer systems is stored as records in files of various formats and sizes. Each of these records provides information for a single transaction or occurrence to be processed by a computer. For example, in the telecommunications industry, a call detail record (CDR) is generated when a telephone call is placed.

Machine or human error may cause the same record to be submitted for processing more than once. For example, call detail records may be undesirably submitted more than once to cause duplicate billing of a customer. Duplicate records should therefore be detected to maintain accuracy in a computer system that processes records.

A brute-force approach can be used to detect duplicate records. This known method compares a record to a database of processed records. The time taken to read and compare each input record against large numbers of records becomes prohibitive using this method. Furthermore, the amount of file storage required for the database of processed records is expensive.

U.S. Pat. No. 5,680,611, Rail et al., entitled “Duplicate Record Detection,” describes a duplicate record detection method. The method computes a checksum for an input record and compares the generated checksum to checksums of a list of non-duplicate records. Although this method is an improvement over the brute-force approach, it nevertheless suffers from a disadvantage. A significant amount of memory is still required for storing the checksums of the non-duplicate records and the method is still computationally intensive because it requires comparing the checksum of the input record against a large set of checksums.

### SUMMARY

According to an aspect of the present invention, there is provided a method of determining if a given record is a duplicate of one of a list of records. A unique piece of information is obtained for the given record. It is determined if the given record is a duplicate by operating on the unique piece of information for the given record and a single piece of information that collectively represents the records in the list.

According to another aspect of the present invention, there is a program storage device readable by a computing device, tangibly embodying a program of instructions, executable by the computing device to perform the above method for determining if a given record is a duplicate of one of a list of records.

According to yet another aspect of the present invention, there is a system for determining if a given record is a duplicate of one of a list of records. The system includes means for obtaining a unique piece of information for the given record and means for determining if the given record is a duplicate of one of the list of records by operating on the unique piece of information for the given record and a single piece of information that collectively represents the records in the list.

### BRIEF DESCRIPTION OF DRAWINGS

The invention will be better understood with reference to the drawings, in which:

FIG. 1 is a flowchart showing a generic sequence of steps for determining if a given record is a duplicate of one of a list of records;

FIG. 2 is a flowchart showing a specific sequence of steps according to an embodiment of the present invention for implementing the generic sequence in FIG. 1; and

FIG. 3 is a block diagram of elements of a computing system that may be used to perform both the generic and the specific sequences of steps in FIGS. 1 and 2.

### DETAILED DESCRIPTION

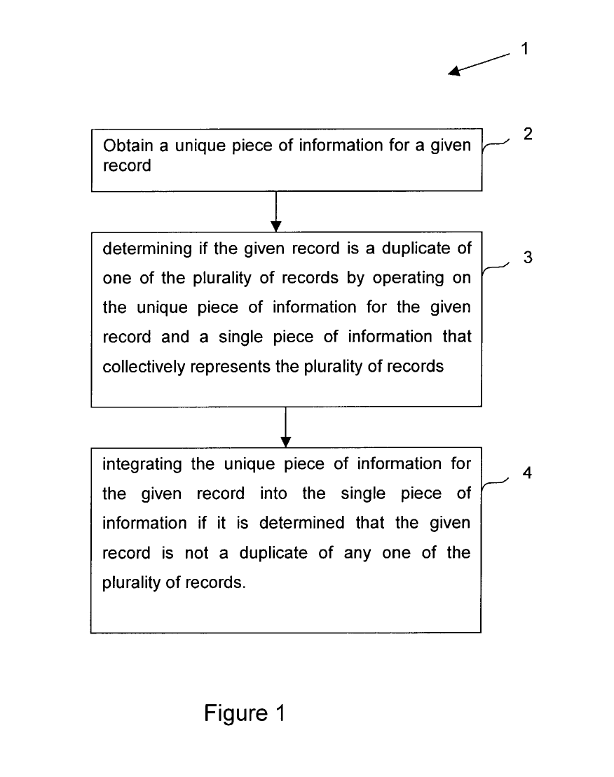

FIG. 1 is a flowchart showing a generic sequence 1 of steps for determining if a given record is a duplicate of one of a list of records that was previously encountered or processed. A single piece of information, hereafter referred to as a collective information, collectively represents the list of previously-encountered records. The generic sequence 1 starts in an OBTAIN UNIQUE INFORMATION step 2, wherein a unique piece of information is obtained for the given record. The sequence 1 next proceeds to a DETERMINE IF RECORD IS A DUPLICATE step 3. In this step 3, it is determined if the given record is a duplicate of one of the previously-encountered records by operating on the unique piece of information for the given record and the collective information. The result of the operation indicates if the given record is a duplicate. The generic sequence 1 finally ends in an UPDATE COLLECTIVE INFORMATION step 4, wherein the collective information is updated to include the unique piece of information for the given record if it is determined that the given record is not a duplicate of any one of the previously-encountered records. A non-duplicate record may then be sent for further processing.

The generic sequence 1 is useful in the telecommunications industry for identifying and discarding duplicate call detail records (CDRs). In such an application, a preprocessor or filter uses the sequence 1 to filter out duplicate CDRs, allowing only non-duplicate CDRs through to a subsequent CDR processing engine for further processing.

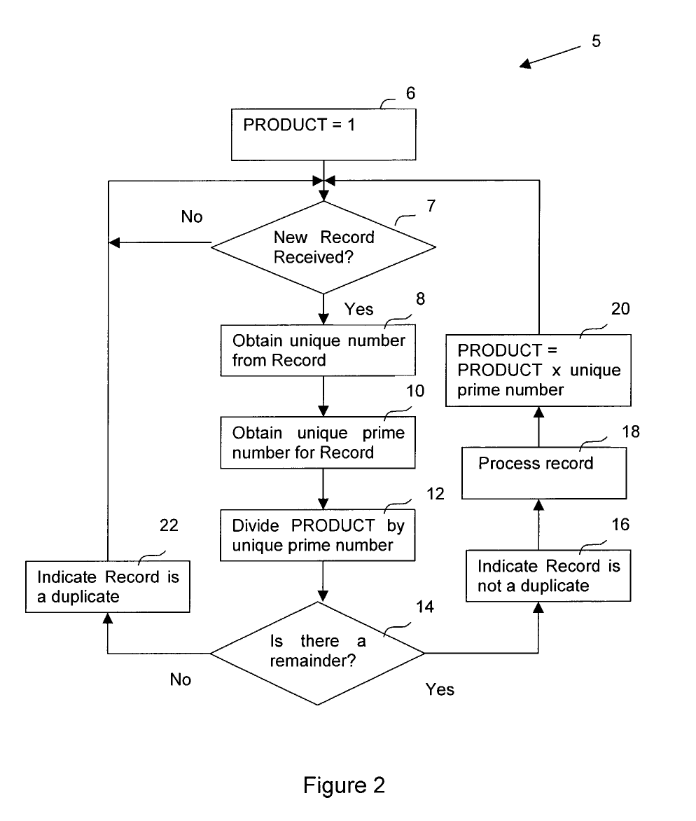

FIG. 2 is a flowchart showing a specific sequence 5 of steps for implementing the generic sequence 1 in FIG. 1 according to an embodiment of the present invention. According to this implementation, the specific sequence 5 starts in an INITIALIZATION step 6, wherein the collective information is stored in a variable, PRODUCT. The value of this variable is initialized to one and will subsequently be updated to collectively include unique prime numbers of all non-duplicate records. At this point in the specific sequence 5, no record has been received.

The specific sequence 5 proceeds to a NEW RECORD RECEIVED? step 7, wherein it is determined if a new record has arrived for processing. If it is determined in this step 7 that no new record has arrived, the specific sequence 5 loops around this step 7 waiting for a new record to arrive. If it is determined that a new record has arrived, the specific sequence 5 proceeds to an OBTAIN UNIQUE NUMBER step 8, wherein a unique piece of information, in this case a unique number (an integer) is obtained for the new record using at least a portion of the record. One method of obtaining a unique number from at least a portion of a record is disclosed in an article by Press, W. H.; Flannery, B. P.; Teukolsky, S. A.; and Vetterling, W. T.; “Cyclic Redundancy and Other Checksums,” found in Section 20.3 of the book Numerical Recipes in FORTRAN: The Art of Scientific Computing, 2nd ed. Cambridge, England: Cambridge University Press, pages 888-895, 1992. The method teaches generation of a cyclic redundancy check (CRC) checksum that can be used as a unique number. Other methods of obtaining a unique number from at least a portion of a record are taught in the following publications:

Harowitz, Sahni, Fundamentals of Computer Algorithms, Computer Science Press;

Aho, Hopcroft, Ullman, Data Structures and Algorithms, Addison Wesley, Reading, Mass. 1999;

Martin Dietzfelbinger, Friedhelm Meyer auf der Heide, High Performance Universal Hashing, with Applications to Shared Memory Simulations, pages 250-269;

“Data Structures and Efficient Algorithms 1992,” Lecture Notes in Computer Science, 594, Springer 1992;

Luby, M, Pseudorandomness and Cryptographic Applications, Princeton, N.J.: Princeton University Press, 1996; and

Wegman, M. N. and Carter, J. L., “New Hash Functions and Their Use in Authentication and Set Equality,” Journal of Computing System Science, No. 22, pages 265-279,1981.

After the unique number for the given record is obtained, the specific sequence 5 proceeds to an OBTAIN UNIQUE PRIME NUMBER step 10, wherein a unique prime number is obtained for the new record. The unique prime number is obtained using the previously-obtained unique number. This unique prime number defines the unique piece of information for a given record in the generic sequence 1. A prime number is a number that is divisible only by itself and unity.

One way of obtaining the unique prime number using the unique number is to select a prime number whose position in a series of ascending prime numbers is given by the unique number. The series of ascending prime numbers is a series starting with the prime number “two.” The unique number may be used as an index into a lookup table of unique prime numbers to obtain a corresponding unique prime number. Such a lookup table for storing a long series of prime numbers will be large. Instead of the use of a lookup table, the prime number may be computed using the unique number according to a formula obtainable from one of the following publications:

Hardy, G. H. and Wright, E. M., “Prime Numbers” and “The Sequence of Primes.” §1.2 and 1.4 in An Introduction to the Theory of Numbers, 5th ed. Oxford, England: Clarendon Press, pages 1-4,1979;

Guy, R. K., “Prime Numbers,” “Formulas for Primes,” and “Products Taken Over Primes,” Ch. A, §A17, and §B48 in Unsolved Problems in Number Theory, 2nd ed. New York: Springer-Verlag, pages 3-43, 36-41 and 102-103, 1994;

Blatner, D.; The Joy of Pi, New York: Walker, page 110, 1997;

Honsberger, R., Mathematical Gems II, Washington, D.C.: Math. Assoc. America, 1976;

Conway, J. H. and Guy, R. K., The Book of Numbers, New York: Springer-Verlag, page 130, 1996; and

Willans C P, “On Formulae for the N^{th} Prime Number,” Mathematical Gazette, Volume 48, pages 413-415,1964.

The specific sequence 5 next proceeds to a DIVISION step 12, wherein the variable (PRODUCT) and the unique prime number are operated on by dividing the variable (PRODUCT) by the unique prime number. It is then determined in a REMAINDER AVAILABLE? step 14 if there is a remainder in the division. If it is determined in the step 14 that the division operation yields a remainder, the specific sequence 5 proceeds to an INDICATE NONDUPLICATE RECORD step 16, wherein the new record is indicated as not having been encountered previously and is therefore a non-duplicate.

The specific sequence 5 next proceeds to a PROCESS RECORD step 18, wherein the non-duplicate record is processed, for example for billing purposes if the record is a CDR. Thereafter, the variable, PRODUCT, is updated by multiplying it with the unique prime number associated with the non-duplicate record in an UPDATE step 20. The variable, PRODUCT, therefore serves the purpose of the single collective piece of information in the generic sequence 1.

If it is however determined in the REMAINDER AVAILABLE? step 14 that the division operation yields no remainder, i.e., the variable PRODUCT is divisible by the unique prime number of the new record, the specific sequence 5 proceeds to a INDICATE DUPLICATE RECORD step 22, wherein the new record is indicated as being a duplicate and is discarded. In a division involving prime numbers, a dividend is divisible by a divisor if the dividend is the same as the divisor or is a product of prime numbers, one of which is the same as the divisor.

It should be noted that the variable, PRODUCT, may be a very large number depending on the number of non-duplicate records and the prime numbers obtained for these records. Consequently, the variable, PRODUCT, has to be declared as a data type that is of a sufficiently large size, for example, a “double” data type if the sequence 1 is implemented using the JAVA programming language. The modulo operation which returns a remainder of a division in the JAVA programming language is able to process operands of different types, for example “double” and “int.” Therefore, when using the JAVA programming language, a variable for holding the unique prime number may be of a data type that is different from that of the variable, PRODUCT.

Such is not the case for other programming languages, for example the C and C++ programming languages. The modulo operation in these other programming languages works with operands that are of the same type and these operands cannot be of type “float” or “double.” If the modulo operation cannot be used to obtain the remainder when the variable of the unique prime number is of a different data type from that of the variable, PRODUCT, a different way of obtaining the remainder is necessary. For example, the remainder may be obtained by repeatedly subtracting the unique prime number from the variable, PRODUCT, until the unique prime number can no longer be subtracted from the variable, PRODUCT. The final value of the variable, PRODUCT, will be the remainder. In such an implementation using repeated subtraction, the initial value of the variable, PRODUCT, will have to be backed up and restored after the modulo operation.

In instances where available variable types cannot support the size of the variable, PRODUCT, the variable may be declared as a string of bytes that is as long as required. Multiplication and division routines involving the variable, PRODUCT, will then have to be written to operate on the variable.

If the product of unique prime numbers for non-duplicate records of a particular application is too large to be stored in a single variable, unique records may be classified, for example according to dates, types of transaction, etc., and stored in separate files according to their classifications. Each of these files has an associated PRODUCT variable. When a new record is received, a unique prime number is obtained for the new record. Thereafter, a PRODUCT variable of a file having the same classification as the new record is divided by the unique prime number to determine if the new record is a duplicate of one of the records in that file.

Alternatively, the non-duplicate records may be stored in separate files without any classification, each file having an associated PRODUCT variable. Each of these PRODUCT variables will have to be divided by the unique prime number of a new record to determine if the new record is a duplicate of any record stored in one of the files.

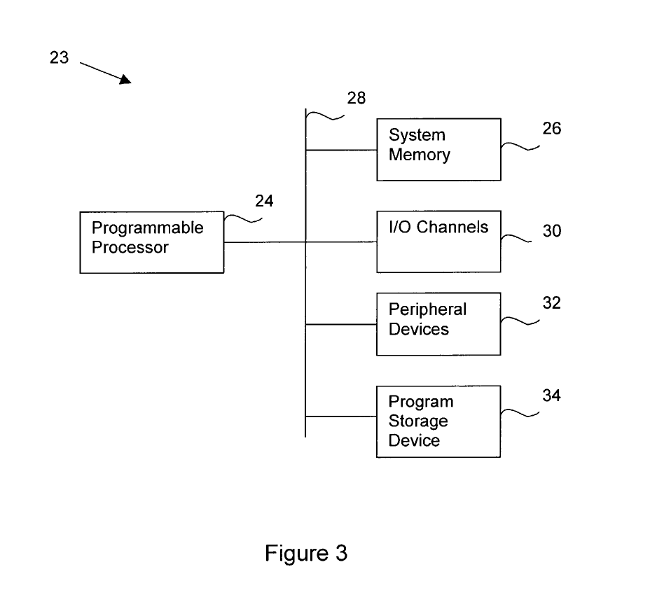

FIG. 3 is a block diagram illustrating typical elements of a computing system 23 that includes means for implementing and practicing the sequences 1, 5. The elements include a programmable processor 24 connected to a system memory 26 via a system bus 28. The processor 24 accesses the system memory 26 as well as other input/output (I/O) channels 30 and peripheral devices 32. The computing system 23 further includes at least one program storage device 34, such as a CD-ROM, tape, magnetic media, EPROM, EEPROM, ROM or the like. The computing system 23 stores one or more computer programs that implement the above-described embodiment of the present invention. The processor 24 reads and executes the one or more computer programs to perform the sequences 1, 5.

Advantageously, the embodiment of the present invention requires less memory compared to the prior art method. Storage is required only for the variable, PRODUCT, compared with storage of a checksum for each record in the prior art.

Although the present invention is described as implemented in the above-described embodiment, it is not to be construed to be limited as such. For example, other known methods of generating unique numbers from at least a portion of records may be used. Similarly, other known methods of generating a unique prime number from a given integer may also be used.

We claim:

1. A method of determining if a given record is a duplicate of one of a plurality of records, the method comprising:
obtaining a unique piece of information for the given record; and
determining if the given record is a duplicate of one of the plurality of records by operating on the unique piece of information for the given record and a single piece of information that collectively represents the plurality of records.

2. A method according to claim 1, further including:
integrating the unique piece of information for the given record into the single collective piece of information if it is determined that the given record is not a duplicate of any one of the plurality of records.

3. A method according to claim 1, wherein obtaining a unique piece of information includes obtaining a unique piece of information defined by a unique prime number for the given record and wherein determining if the given record is a duplicate includes:
dividing the single collective piece of information defined by a product of similarly-obtained unique prime numbers for the plurality of records by the unique prime number associated with the given record; and
determining if the given record is a duplicate based on whether the product is divisible.

4. A method according to claim 3, further including:
updating the product by multiplying it with the unique prime number associated with the given record to integrate the unique prime number into the product if it is determined that the given record is not a duplicate of any one of the plurality of records.

5. A method according to claim 3, wherein obtaining a unique prime number for the given record and each of the plurality of record includes:
obtaining a unique number for a record; and
obtaining a unique prime number using the unique number obtained.

6. A method according to claim 4, wherein obtaining a unique prime number using the unique number includes obtaining a prime number whose position in a series of ascending prime numbers is given by the unique number.

7. A method according to claim 5, wherein obtaining a unique prime number using the unique number includes computing a prime number whose position in a series of ascending prime numbers is given by the unique number.

8. A program storage device readable by a computing device, tangibly embodying a program of instructions, executable by the computing device to perform a method of determining if a given record is a duplicate of one of a plurality of records, the method comprising:
obtaining a unique piece of information for the given record; and
determining if the given record is a duplicate of one of the plurality of records by operating on the unique piece of information for the given record and a single piece of information that collectively represents the plurality of records.

9. A program storage device according to claim 8, further including:
integrating the unique piece of information for the given record into the single piece of information if it is determined that the given record is not a duplicate of any one of the plurality of records.

10. A program storage device according to claim 8, wherein obtaining a unique piece of information includes obtaining a unique piece of information defined by a unique prime number for the given record and wherein determining if the given record is a duplicate includes:
dividing the single collective piece of information defined by a product of similarly-obtained unique prime numbers for the plurality of records by the unique prime number associated with the given record; and
determining if the given record is a duplicate based on whether the product is divisible.

11. A program storage device according to claim 10, further including:
updating the product by multiplying it with the unique prime number associated with the given record to integrate the unique prime number into the product if it is determined that the given record is not a duplicate of any one of the plurality of records.

12. A program storage device according to claim 10, wherein obtaining a unique prime number for the given record and each of the plurality of record includes:
obtaining a unique number for a record; and
obtaining a unique prime number using the unique number obtained.

13. A program storage device according to claim 12, wherein obtaining a unique prime number using the unique number includes obtaining a prime number whose position in a series of ascending prime numbers is given by the unique number.

14. A program storage device according to claim 13, wherein obtaining a unique prime number using the unique number includes computing a prime number whose position in a series of ascending prime numbers is given by the unique number.

15. A system for determining if a given record is a duplicate of one of a plurality of records, the system comprising:
means for obtaining a unique piece of information for the given record; and
means for determining if the given record is a duplicate of one of the plurality of records by operating on the unique piece of information for the given record and a single piece of information that collectively represents the plurality of records.

16. A system according to claim 15, further including:
means for integrating the unique piece of information for the given record into the single piece of information if it is determined that the given record is not a duplicate of any one of the plurality of records.

17. A system according to claim 15, wherein the means for obtaining a unique piece of information includes means for obtaining a unique piece of information defined by a unique prime number for the given record and wherein the means for determining if the given record is a duplicate includes:
means for dividing the single collective piece of information defined by a product of similarly-obtained unique prime numbers for the plurality of records by the unique prime number associated with the given record; and
means for determining if the given record is a duplicate based on whether the product is divisible.

18. A system according to claim 17, further including:
means for updating the product by multiplying it with the unique prime number associated with the given record to integrate the unique prime number into the product if it is determined that the given record is not a duplicate of any one of the plurality of records.
